(19) United States
(12) Patent Application Publication
(10) Pub. No.: US 2026/0187592 A1
(43) Pub. Date: Jul. 2, 2026

(54) COMPUTER SYSTEMS AND METHODS FOR IMPLEMENTING IDEA DEVELOPMENT PROJECTS

(71) Applicant: Capital One Financial Corporation, McLean, VA (US)

(72) Inventors: Daniel A. Gisolfi, Hopewell Junction, NY (US); Bryce Curtis, Apex, NC (US); Yessel Hinojosa Martinez, Austin, TX (US); Aaron Reed, Cary, NC (US); Evan Kountouris, Raleigh, NC (US)

(21) Appl. No.: 19/007,285

(22) Filed: Dec. 31, 2024

(51) Int. Cl. G06Q 10/101; G06Q 10/0631

(52) U.S. Cl. CPC G06Q 10/101; G06Q 10/063118

(57) ABSTRACT

A computing platform configured to: (i) create a template defining (a) roles for users collaborating on a project, (b) a first and second phase for the project, each comprising respective tasks for users having a first role, and (c) settings defining which tasks users having each role can complete, (ii) during the first phase, receive a request for a user having the first role to access the project, (iii) cause a client device to present a visualization that enables the user to complete tasks for the first phase corresponding to the first role and restricts the user from completing other tasks, (iv) during the second phase, receive a request for the user to access the project, and (v) cause the client device to present a visualization that enables the user to complete tasks for the second phase corresponding to the first role and restricts the user from completing other tasks.

### BACKGROUND

Innovation is an integral part of every industry—at every level. To remain competitive, enterprises lean into research and development in order to create, develop, and implement new products—as well as to update and/or refine existing products. To streamline innovation, an enterprise may adopt an innovation methodology template that defines, among other things, the tasks involved in idea development projects that can be completed to move ideas from conception through maturation into implementation-ready products.

### OVERVIEW

Disclosed herein is new software technology for an ideation hub software application that carries out various innovation methodology templates to implement idea development projects.

In one aspect, the disclosed software technology may take the form of a method to be carried out by a computing platform that involves (i) creating an innovation methodology template for an idea development project, the innovation methodology template defining (a) a set of roles for respective users collaborating on the idea development project, (b) a set of phases for the idea development project including at least a first phase and a second phase, wherein the first phase and second phase each include a respective set of role-based tasks that may be completed by users having a first role of the set of roles, and (c) a respective set of access permission settings for each role of the set of roles, wherein each set of access permission settings defines which role-based tasks users having the role can complete for the idea development project, (ii) creating a data object for the idea development project based on the created innovation methodology template, (iii) while the first phase is open, receiving, from a client device associated with a user having the first role for the idea development project, a first request to access the data object for the idea development project, (iv) based on the set of access permission settings for the first role, causing the client device to present a first visualization of the data object for the idea development project, wherein the first presented visualization (a) includes selectable elements for the set of role-based tasks for the first phase of the idea development project corresponding to the first role, (b) enables the user to complete the set of role-based tasks for the first phase of the idea development project corresponding to the first role, and (c) restricts the user from completing other role-based tasks, (v) after the first phase is closed and while the second phase is open, receiving, from the client device associated with the user having the first role for the idea development project, a second request to access the data object for the idea development project, and (vi) based on the set of access permission settings for the first role, causing the client device to present a second visualization of the data object for the idea development project, wherein the second presented visualization (a) includes selectable elements for the set of role-based tasks for the second phase of the idea development project corresponding to the first role, (b) enables the user to complete the set of role-based tasks for the second phase of the idea development project corresponding to the first role, and (c) restricts the user from completing other role-based tasks.

The second presented visualization may take various forms, and in some example embodiments, the second presented visualization may also include nonselectable elements for the set of role-based tasks for the first phase of the idea development project corresponding to the first role. Further, in some example embodiments, the second phase further includes a set of role-based tasks that may be completed by users having a second role of the set of roles, and in such example embodiments, the second presented visualization may also include nonselectable elements for the set of role-based tasks for second phase of the idea development project corresponding to the second role.

Further, in some example embodiments, the method may further involve (vii) receiving an indication of a request to create the innovation methodology template, and in such example embodiments, the functionality for creating the innovation methodology template may further involve creating the innovation methodology template based on the received indication of the request to create the innovation methodology template.

Further yet, in some example embodiments, the first phase may further include a set of role-based tasks that may be completed by users having a second role of the set of roles, and in such example embodiments, the method may further involve (vii) while the first phase is open, receiving, from a second client device associated with a second user having the second role for the idea development project, a third request to access the data object for the idea development project, and (viii) based on the set of access permission settings for the second role, causing the second client device to present a third visualization of the data object for the idea development project, wherein the third presented visualization (a) includes the set of role-based tasks for the first phase of the idea development project corresponding to the second role, (b) enables the second user to complete the set of role-based tasks for the first phase of the idea development project corresponding to the second role, and (c) restricts the second user from completing other role-based tasks. Further, in some example embodiments, the third presented visualization may also include nonselectable elements for the set of role-based tasks for first phase of the idea development project corresponding to the first role. Further yet, in some example embodiments, the second phase may further include a set of role-based tasks that may be completed by users having the second role, and in such example embodiments, the method may further involve (ix) while the second phase is open, receiving, from the second client device associated with the second user having the second role for the idea development project, a fourth request to access the data object for the idea development project, and (x) based on the set of access permission settings for the second role, causing the second client device to present a fourth visualization of the data object for the idea development project, wherein the fourth presented visualization (a) includes the role-based tasks for the second phase of the idea development project corresponding to the second role, (b) enables the second user to complete the role-based tasks for the second phase of the idea development project corresponding to the second role, and (c) restricts the second user from completing other role-based tasks.

Further, in some example embodiments, the method may further involve (vii) creating a second data object for a second idea development project based on the created innovation methodology template.

In another aspect, the disclosed technology may take the form of a computing platform comprising at least one processor, at least one non-transitory computer-readable medium, and program instructions stored on the at least one non-transitory computer-readable medium that, when executed by the at least one processor, cause the computing platform is configured to carry out the functions of the aforementioned method.

In yet another aspect, the disclosed technology may take the form of a non-transitory computer-readable medium, wherein the non-transitory computer-readable medium is provisioned with program instructions that, when executed by at least one processor, cause a computing platform to carry out the functions of the aforementioned method.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example network configuration in accordance with the present disclosure.

FIG. 2 illustrates an example network configuration in which an ideation hub software application may be implemented in accordance with the present disclosure.

FIG. 3 illustrates an example flow diagram showing one possible example of operations that may be carried out to create an innovation methodology template for use in creating data objects representing idea development projects in accordance with the present disclosure.

FIG. 4 illustrates an example flow diagram showing one possible example of operations that may be carried out to create a data object for an idea development project using an innovation methodology template in accordance with the present disclosure.

FIG. 5 illustrates an example visualization of a first interface view that may be presented by a client device for creating an idea creation submission in accordance with the present disclosure.

FIG. 6 illustrates an example visualization of a second interface view that may be presented by a client device for creating an idea creation submission in accordance with the present disclosure.

FIG. 7A illustrates an example visualization of a data object for an idea development project that may be created in accordance with the present disclosure.

FIG. 7B illustrates an example visualization of a data object for an idea development project that may be created in accordance with the present disclosure.

FIG. 8 illustrates an example flow diagram showing one possible example of operations that may be carried out to add entities to an idea development project in accordance with the present disclosure.

FIG. 9 illustrates an example visualization of a community hub interface view that may be presented via a client device in accordance with the present disclosure.

FIG. 10 is a simplified block diagram that illustrates some structural components of an example computing platform that may be configured to carry out any of the various functions disclosed herein.

FIG. 11 is a simplified block diagram that illustrates some structural components of an example client device that may be configured to carry out any of the various functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

Innovation is an integral part of every industry—at every level. To remain competitive, enterprises lean into research and development in order to create, develop, and implement new products—as well as to update and/or refine existing products. (While the end-result of an idea is referred to herein as a product, it should be understood that the end-result of an idea may take other forms as well, such as a service and/or a process, an improvement to an existing product, service, or process, among other possibilities.) To streamline innovation, an enterprise may adopt an innovation methodology template that defines, among other things, the tasks involved in idea development projects that can be completed to move ideas from conception through maturation into implementation-ready products.

The tasks defined by the innovation methodology template may be organized in various ways. For instance, as one possibility, the innovation methodology template may define a set of phases that establish the progression of an idea development project from conception through maturation. Other possibilities may also exist. Further, the tasks defined by the innovation methodology template may take any of various forms, and some example tasks may include: describing a problem to be solved, describing a solution to the problem, describing the costs (e.g., financial costs, time costs, or other resource costs) involved in implementing the solution, obtaining approval for implementing the solution, and implementing the solution, among various other tasks. The tasks defined by the innovation methodology template may take various other forms as well.

Given the fact that ideas often involve various disciplines, idea development projects may benefit from the collaboration of multiple entities. As one example, experts in fields relevant to certain idea development projects may have valuable insights that they can contribute to the idea development projects. As another example, managers may be responsible for reviewing the progress of idea development projects. As yet another example, stakeholders may have the financial and other resources needed to sponsor idea development projects as they progress to maturation. There may be various other entities that can collaborate to help idea development projects progress to maturation.

Defining the progression of an idea development project in this way (e.g., as a set of phases with role-based tasks within each phase) may allow entities involved in idea development projects to easily understand the process for progressing an idea from conception to maturation.

Professionals at every level struggle with the intensity of focus and attention that is required to manage idea development projects. Even if an enterprise adopts an innovation methodology template, they often lack the technological tools to implement the methodology template in flexible and accessible way. As a result, without such technological tools, professionals lack the structure and resources needed in order to develop, refine, collaborate on, and find sponsorship to act on impactful ideas. Further, market and customer needs will not sit idle while enterprises wrestle with internal barriers and inefficient processes. Accordingly, to keep a competitive edge, enterprises need access to technological tools and resources that include functionality for implementing innovation methodology templates in an accessible way, and that facilitate convenient and well-defined collaboration opportunities throughout the progression of idea development projects from conception to maturation.

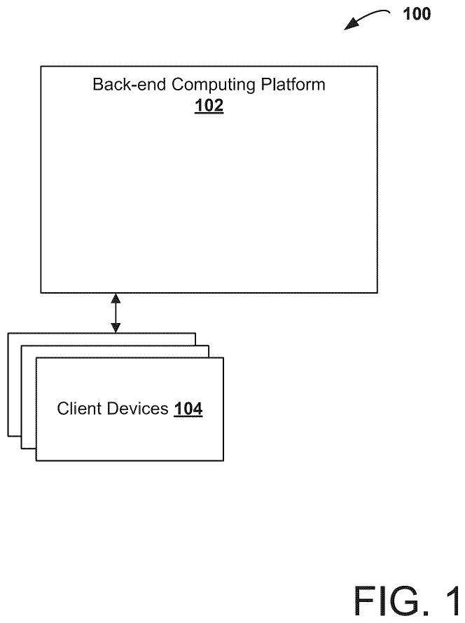

Currently, there are several software applications that include some functionality for implementing predefined innovation methodology templates. FIG. 1 depicts an example network configuration 100 in which an enterprise may utilize existing technology to implement predefined innovation methodology templates for completing idea development projects. As shown in FIG. 1, the example network configuration 100 includes a back-end computing platform 102 and a plurality of client devices 104.

Broadly speaking, the back-end computing platform 102 may comprise one or more computing platforms that collectively comprise some set of physical computing resources (e.g., one or more processors, one or more data stores, one or more communication interfaces, etc.) along with back-end software for carrying out back-end functionality for implementing predefined innovation methodology templates for completing idea development projects. As one possibility, the back-end computing platform 102 may comprise cloud computing resources supplied by a third-party provider of “on demand” cloud computing resources, such as Amazon Web Services (AWS), Amazon Lambda, Google Cloud, Microsoft Azure, or the like. As another possibility, the back-end computing platform 102 may comprise “on-premises” computing resources of the given software provider (e.g., servers owned by the given software provider). As yet another possibility, the back-end computing platform 102 may comprise a combination of cloud computing resources and on-premises computing resources. Other implementations of the back-end computing platform 102 are possible as well.

The back-end computing platform 102 may include various other functional components as well, which may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Turning to the client devices 104, each client device 104 may generally take the form of any computing device that is capable of running client-side software for interacting with the back-end computing platform 102. In this respect, each client device 104 may include hardware components such as one or more processors, computer readable mediums, communication interfaces, and input/output (I/O) components (or interfaces for connecting thereto), among other possible hardware components, as well as software components such as operating system (OS) software, web browser software, and/or other client-side software for accessing and interacting with the back-end computing platform 102, among other possible software components. As representative examples, each client device 104 may take the form of a desktop computer, a laptop, a netbook, a tablet, a smartphone, or a personal digital assistant (PDA), among other possibilities.

As further depicted in FIG. 1, each client device 104 may be configured to communicate with the back-end computing platform 102 over a respective communication path. Each of these communication paths may generally comprise one or more data networks and/or data links, which may take any of various forms. For instance, each respective communication path between a client device 104 and the back-end computing platform 102 may include any one or more of a Personal Area Network (PAN), a Local Area Network (LAN), a Wide Area Networks (WAN) such as the Internet or a cellular network, a cloud network, and/or a point-to-point data link, among other possibilities, where each such data network and/or link may be wireless, wired, or some combination thereof, and may carry data according to any of various different communication protocols. Additionally, the communication between a client device 104 and the back-end computing platform 102 may be carried out via an Application Programming Interface (API) provided by the back-end computing platform 102, among other possibilities. Although not shown, the respective communication paths between the client devices 104 and the back-end computing platform 102 may also include one or more intermediate systems, examples of which may include a data aggregation system and host server, among other possibilities. Many other configurations are also possible.

As previously mentioned, the example network configuration 100 may be used to implement existing technology for implementing predefined innovation methodology templates for idea development projects. For instance, an entity operating a client device 104 may use the client-side software for interacting with the back-end computing platform 102 to implement a predefined innovation methodology template for an idea development project using existing technology. However, while these predefined innovation methodology templates may fit some circumstances, enterprises need a tool that is configurable to implement user-defined, enterprise-specific innovation methodology templates.

Existing technology does not provide functionality to support a meaningful level of organization for collaborative efforts in idea development projects. While existing technology offers some features, such as general discussion boards for collaborating on projects by asking questions and posting replies to provide insights to questions, existing technology does not provide a framework for telling collaborators who is responsible for performing which tasks in idea development projects.

Further yet, existing technology does not provide functionality for enforcing who can interact with an idea development project at any given time. This lack of enforcement can lead to several issues, such as (i) confusion regarding which tasks have been completed and whether it is timely to complete certain tasks and (ii) rework to correct for mistakes caused by said confusion.

Further yet, existing technology does not provide functionality for enabling idea development project owners to find qualified entities to collaborate with. For instance, an idea development project may involve highly technical subject matter, and an owner of the project may desire to collaborate with qualified entities who are competent in the subject matter. However, such functionality is not supported in existing technology. As previously mentioned, existing technology provides functionality for using a discussion board or the like to facilitate simple forms of collaboration between entities. However, these types of platforms rely on broad—and sometimes even anonymous—community engagement to gather insights, and do not facilitate a way for idea development project owners to find qualified entities to collaborate with on their projects. The existing technology suffers from various other shortcomings, and falls short of provide a set of features comprehensive enough to fully implement the various types of innovation methodology templates that enterprises may desire to use for their idea development projects.

In view of these challenges and the shortcomings of existing technology, disclosed herein is new technology taking the form of an ideation hub software application that carries out various innovation methodology templates to implement idea development projects.

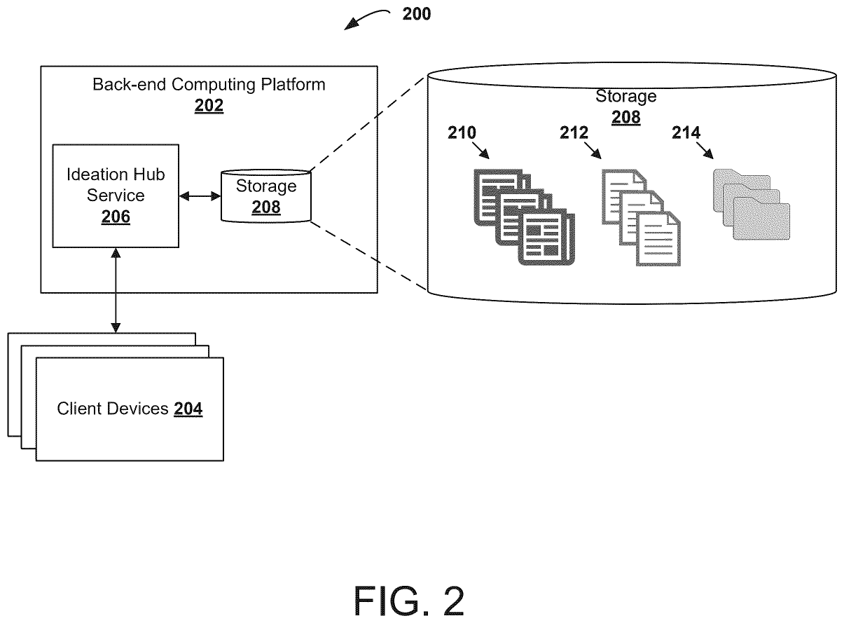

Turning now to FIG. 2, an example network configuration 200 is illustrated, in which the ideation hub software application discussed herein has been implemented. As with the example network configuration 100 of FIG. 1, the example network configuration 200 includes a back-end computing platform 202 and a plurality of client devices 204. However, unlike the example network configuration 100 of FIG. 1, the example network configuration 200 of FIG. 2 further includes an ideation hub service 206 and storage 208. The ideation hub service 206 may take the form of a functional component implemented in software that is configured to perform back-end functionality for the ideation hub software application, as described herein. Further, each client device 204 may be installed with client-side software for the ideation hub software application and/or a web browser, through which the client devices 204 may interact with the ideation hub service 206. Further, the users of the client devices 204 may be employees of an enterprise that utilizes the ideation hub service 206 to develop idea development projects created by employees of the enterprise, or other entities that may collaborate on such idea development projects, among other possibilities.

The ideation hub service 206 includes various functionality to address the many shortcoming of existing technology for implementing innovation methodology templates for idea development projects. The functionality of the ideation hub service 206 may take various forms.

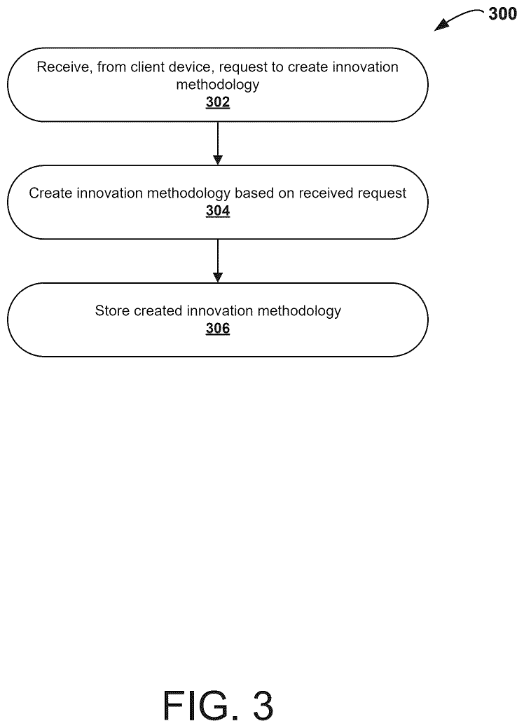

For example, the ideation hub service 206 may include functionality for creating innovation methodology templates. To accomplish this, the ideation hub service 206 may be configured to (i) receive a request to create an innovation methodology template, e.g., from a client device 204, (ii) create the innovation methodology template based on the received request, and then (iii) store the created innovation methodology template within the storage 208, among other things. As shown in FIG. 2, an exploded view of the storage 208 includes a plurality of innovation methodology templates 210 that may be stored by the ideation hub service 206 within the storage 208. Further details regarding creating and storing innovation methodology templates are discussed below with respect to FIG. 3.

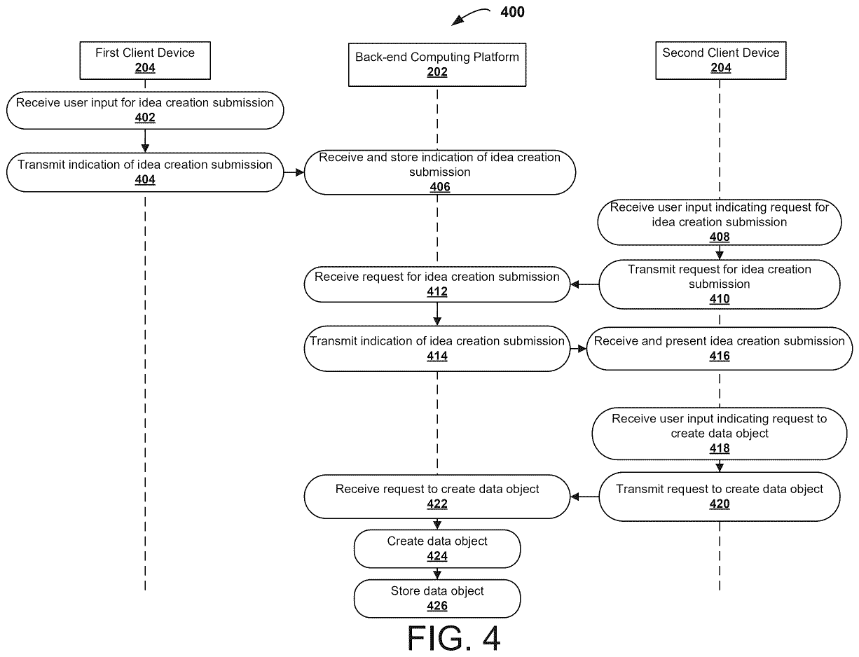

As another example, the ideation hub service 206 may include functionality for creating data objects representing idea development projects. To accomplish this, the ideation hub service 206 may be configured to (i) receive a request to create a data object for an idea development project, e.g., from a client device 204, (ii) create the data object based on the received request and an applicable innovation methodology template (e.g., from the plurality of innovation methodology templates 210), and then (iii) store the created data object within the storage 208, among other things. As shown in FIG. 2, the exploded view of the storage 208 also includes a plurality of data objects 212 for idea development projects that may be stored by the ideation hub service 206 within the storage 208. Further details regarding creating and storing data objects representing idea development projects are discussed below with respect to FIGS. 4-7B.

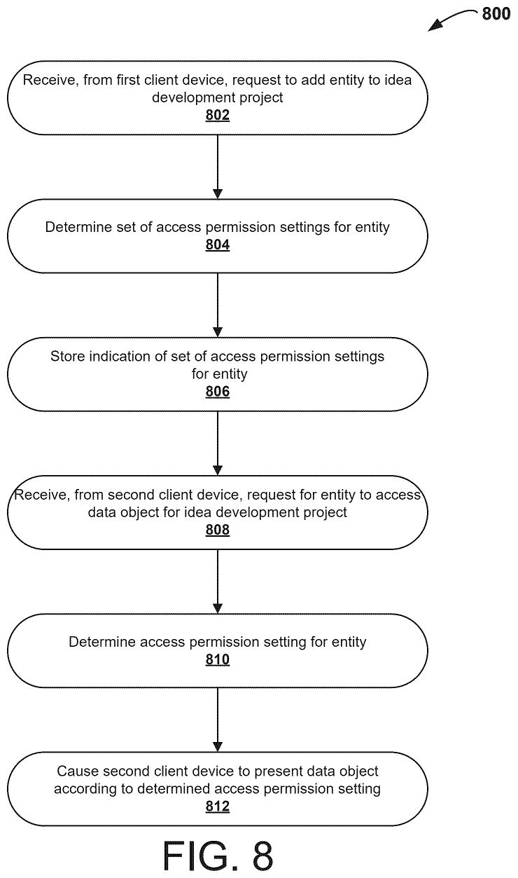

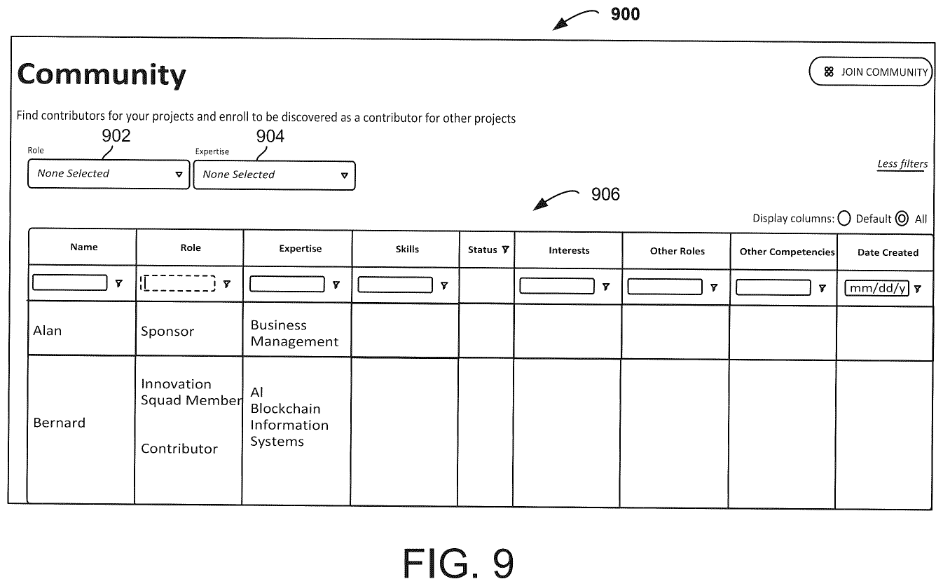

As another example, the ideation hub service 206 may include functionality for establishing collaboration for idea development projects. To accomplish this, the ideation hub service 206 may be configured to (i) receive a request to add an entity having a given role to an idea development project, e.g., from a client device 204, (ii) determine a set of access permission settings for the requested entity based on the given role of the requested entity and the innovation methodology template implemented for the idea development project, and then (iii) store the determined set of access permission settings for the requested entity within the storage 208, among other things. As shown in FIG. 2, the exploded view of the storage 208 includes a plurality of sets of access permission settings 214, which may include access permission settings for entities having respective roles on a by-idea development project-basis. The ideation hub service 206 may use the sets of access permission settings to determine how and when tasks for an idea development project may be completed. This may involve facilitating the completion of tasks of each phase according to the innovation methodology template. For instance, if the innovation methodology template defines a sequential order for various tasks, then the ideation hub service 206 may restrict access to certain tasks until it is time—according to the sequential order defined by the innovation methodology template—for those tasks to be completed. Further, if the innovation methodology template defines role-based tasks that are to be completed by entities having corresponding roles, then the ideation hub service 206 may restrict access to those role-based tasks such that they are only accessible for completion by entities having the corresponding roles. Further details regarding establishing collaboration for idea development projects and determining how and when tasks for idea development projects may be completed are discussed below with respect to FIGS. 8-9.

As yet another example, the ideation hub service 206 may include functionality for interlocking idea development projects with other management systems. For instance, the ideas that are involved in idea development projects may be useful in other contexts, such as for developing patents or other forms of innovation. Accordingly, the ideation hub service 206 may include functionality that enables entities to conveniently integrate idea development projects into those other contexts. For instance, as described in greater detail below, an idea development project may be used to begin the process for preparing a new patent disclosure form based on the idea development project. Various other examples may also exist.

As yet another example, the ideation hub service 206 may include functionality for analyzing and deriving metrics associated with idea development projects. For instance, the ideation hub service 206 may track common ideas included in various idea development projects, and may enable entities to identify similarities between various idea development projects. This may reduce duplicative work and facilitate greater collaboration, as principles from a first idea development project may be incorporated into a second idea development project to help develop the second idea development project. As another example, the ideation hub service 206 may track any dependencies between different idea development projects. For instance, if multiple idea development projects indicate a need for a common resource, then metrics related to the availability of that common resource may be analyzed to determine any issues that may arise, e.g., regarding a delays in the development of idea development projects based on the limited availability of the common resource. Various other examples may also exist.

The ideation hub service 206 may be configured to carry out various other functions as well.

It should be understood that the example network configuration 200 depicted in FIG. 2 is one example of a network configuration in which the disclosed technology may be implemented. Numerous other arrangements are possible and contemplated herein. For instance, other network configurations may include additional components not pictured and/or more or fewer of the pictured components.

The disclosed technology improves upon existing technology for implementing innovation methodology templates for idea development projects in various ways. The disclosed technology enables entities to create and implement any innovation methodology template for idea development projects, allowing for greater control over what forms idea development projects may take than what is supported by existing technology. Further, the disclosed technology supports a configurable and well-defined implementation for what roles entities may hold for collaborating on idea development projects and, relatedly, what tasks those entities may be able to complete and at what times during development, which is lacking in existing technology. Further yet, the disclosed technology enables entities to identify and recruit qualified collaborators, whereas existing technology relies on a more anonymous, general form of collaboration. Further yet, the disclosed technology enables entities to hold different roles for different idea development projects, unlike existing technology. The disclosed technology improves upon existing technology in various other ways as well.

Turning now to FIG. 3, an example flow diagram 300 shows one possible example of operations that may be carried out to create an innovation methodology template for use in creating data objects representing idea development projects, in accordance with the present disclosure. As shown, the operations of the example flow diagram 300 are performed by the back-end computing platform 202, although it should be noted that the operations of the example flow diagram 300 may be performed by other devices and/or platforms. Moreover, the blocks shown in the example flow diagram 300 may be rearranged into different orders, combined into fewer blocks, separated into additional blocks, and/or removed, based on the particular embodiment. The example flow diagram 300 may also be modified to include additional blocks that represent other functionality that is described expressly or implicitly elsewhere herein.

At block 302, the back-end computing platform 202 may receive, from a client device 204, a request to create an innovation methodology template. The request to create an innovation methodology template may define various aspects of the innovation methodology template.

The request may define a set of roles that may be assumed by entities collaborating on idea development projects created according to the innovation methodology template. Some example roles that the request may define may include (i) an idea owner role, (ii) a contributor role, (iii) a reviewer role, (iv) an innovation squad member role, and/or (v) a sponsor role. In practice, the request may define various other roles in addition to or instead of these example roles.

The request may also define a set of phases for idea development projects created using the innovation methodology template, wherein each phase may include a respective set of role-based tasks for one or more of the defined roles. The request may define various phases, and may define various role-based tasks for each phase.

A first example phase that may be defined may include role-based tasks that may be completed by an entity having the idea owner role. Such as role-based tasks may include (i) describing a new idea for which an idea development project is to be created, and (ii) recruiting one or more entities to collaborate on the idea development project, among other possible role-based tasks.

A second example phase that may be defined may include different sets of role-based tasks to be completed by entities having different roles. For instance, the second example phase may include a first set of role-based tasks that may be completed an entity having the idea owner role to further describe the problem that the idea development project is addressing, the solution proposed by the idea development project, and any other considerations for the idea development project (e.g., estimated costs, resources needed, etc.), among other possible role-based tasks that may be assigned to the entity having the idea owner role. The second example phase may also include a second set of role-based tasks that may be completed by entities having the contributor role to provide insights to the idea development project, e.g., by completing tasks to supplement the answers provided by the entity having the idea owner role, among other possible role-based tasks that may be assigned to entities having the contributor role. The second example phase may also include a third set of role-based tasks that may be completed by entities having the reviewer role to provide feedback to the responses provided by the entities having the idea owner role and/or the contributor role, such as by approving/rejecting the responses, providing feedback or suggestions to the responses, and requesting that those responses be revised to address the provided feedback, among other possible role-based tasks that may be assigned to entities having the reviewer role. The second example phase may also include a fourth set of role-based tasks that may be completed by entities having the sponsor role to review and approve/reject the tasks performed for the second phase, finance any work needed for the second phase, among other possible role-based tasks that may be assigned to entities having the reviewer role. The second phase may take other forms as well.

Various other phases may also be defined, and the phases may include other sets of role-based tasks to be completed by entities having other roles. For instance, a given phase may include a set of role-based tasks that may be completed by entities having the innovation squad member role to implement various aspects of idea development projects, e.g., by creating mockups, models, schematics, etc. for the idea development projects, among other possible role-based tasks that may be assigned to entities having the innovation squad member role. Other possibilities may also exist.

Further, in some implementations, the first phase for idea development projects may be defined as a default phase. In such implementations, the request to create the innovation methodology template may not specifically define the first phase, rather the first phase may be added by default for any idea development project that is created by an innovation methodology template. This first phase may be referred to herein as the idea creation phase, and in line with the previous discussion, may include role-based tasks that may be completed by an entity having the idea owner role such as role-based tasks for (i) describing a new idea for which an idea

development project is to be created, and (ii) recruiting one or more entities to collaborate on the idea development project, among other possible role-based tasks.

The request to create the innovation methodology template may also define how the innovation methodology template is to control when and by whom role-based tasks may be completed for idea development projects. As one example, the innovation methodology template may be defined such that role-based tasks of each phase of an idea development project may only be completed when the phase is open. To illustrate with an example scenario, when an idea development project is beginning, the first phase may be open, and role-based tasks of the first phase may be completed, e.g., by an entity having the idea owner role, but the other phases that are defined by the innovation methodology template may be closed, such that the role-based tasks of those phases may not be completed yet. In some implementations, the role-based tasks of closed phases may be viewable, but not editable, while in other implementations, the role-based tasks of closed phases may neither be viewable nor editable. Other implementations may also exist. Continuing the example scenario, when the idea development project has progressed from the idea creation phase to a second phase (e.g., after an entity having the sponsor role has approved the idea creation phase), then the second phase may be opened and the idea creation phase may become closed. This may continue with the other phases as well, as the idea development project progresses. In some implementations, once the progression of the idea development project transitions from one phase to another, the former phase may be identified as a completed phase, and the role-based tasks in the completed phase may be locked from further revisions. Further, in some implementations, entities having a certain role (e.g., a sponsor role) may be enabled to unlock certain role-based tasks for revision as needed. Various other implementations may also exist.

As another example, the innovation methodology template may be defined such that role-based tasks may only be completed by entities having a corresponding role. In some implementations, this may be accomplished by only including role-based tasks that correspond to the role held by a given entity when the given entity navigates to a visualization of the idea development project (e.g., via a user interface of a client device 204). In other implementations, this may be accomplished by causing role-based tasks that do not correspond to the role held by a given entity to be nonselectable, and/or uneditable in other ways, in a visualization of the idea development project. Various other implementations may also exist. The request may define how the innovation methodology template is to control when and by whom role-based tasks may be completed for idea development projects in other ways as well.

The request to create the innovation methodology template may define other aspects of the innovation methodology template as well, such as (i) what types of attachments may be added to idea development projects created by the innovation methodology template, (ii) what types of other interconnection may exist between idea development projects created by the innovation methodology template and other contexts (e.g., whether patent disclosures may be created based on the idea development projects, etc.), and/or (iii) what types of metrics are analyzed and derived for idea development projects created by the innovation methodology template, among various other examples.

In practice, the request to create the innovation methodology template may be transmitted by the client device 204 and may be based on user input provided to the client device 204. For instance, a user operating the client device 204 may use the client-side software for the ideation hub software application to provide input to define the innovation methodology template. As an example scenario, the user may belong to an enterprise that holds an account with the ideation hub software application, and the enterprise may include the various employees of the enterprise as users of the account. Other possibilities may also exist, including the possibility that each employee of the enterprise may have their own account with the ideation hub software application, as well as the possibility that other parties outside of the enterprise may also be users of accounts, and may collaborate with employees of the enterprise on idea development projects. In this example scenario, the user may, e.g., after signing into the account, navigate through the ideation hub software application until the client device 204 presents an interface for defining the innovation methodology template. The interface for defining the innovation methodology template may take any of various forms.

As one possibility, the interface may enable the user to input a request for a user-defined innovation methodology template to be created. For instance, the interface may include a plurality of selectable icons that the user may interact with to define various aspects of the innovation methodology template to be created. These selectable icons may take various forms, and some example selectable icons may include input fields for inputting various aspects of the innovation methodology template and/or lists of predefined options, from which the user may select one or more options to define various aspects of the innovation methodology template. The selectable icons may take other forms as well.

As another possibility, the interface may enable the user to input a request for a predefined innovation methodology template to be utilized, e.g., instead of creating a new innovation methodology template. For instance, the interface may include a selectable list of predefined innovation methodology template options, and the user may select a predefined innovation methodology template option from the list for use. These predefined innovation methodology templates may take any of various forms, and may include things such as predefined tasks, predefined roles, and/or a predefined logical flow, among other examples. Further, these predefined innovation methodology templates may be predefined by an entity of the enterprise, included, e.g., by default, in the ideation hub software application, and/or obtained from one or more third parties.

Other possibilities may also exist, including the possibility that the interface may include features such that the user is enabled to select between inputting a request for a user-defined innovation methodology template to be created, inputting a request for a predefined innovation methodology template to be utilized, or editing a predefined innovation methodology template to develop a new user-defined innovation methodology template.

The interface for defining the innovation methodology template may take other forms as well.

After the user navigates to the interface for defining the innovation methodology template, the user may (i) provide input to define the various aspects of the innovation methodology template and/or (ii) provide input to select a predefined innovation methodology template option, and then submit a request for the user-defined innovation methodology and/or predefined innovation methodology template to be utilized. The client device 204 may transmit the an indication of the request to the back-end computing platform 202, e.g., via the communication path between the client device 204 and the back-end computing platform 202.

At block 304, the back-end computing platform 202 may create an innovation methodology template based on the received request. The back-end computing platform 202 may create the innovation methodology template in various ways, such as by creating a data structure (e.g., a Json object or the like) that includes data representing (i) the set of roles defined for the innovation methodology template, (ii) the set of phases defined for the innovation methodology template, and (iii) any other features defined for the innovation methodology template, in line with the previous discussion.

Additionally, the back-end computing platform 202 may create a state machine to implement the innovation methodology template, e.g., based on the received request. The state machine may represent the various role-based tasks of each phase defined for the innovation methodology template, and may determine, e.g., based on rules defined for the state machine, when phases are open, closed, or completed, as well as when various role-based tasks may be completed (and/or viewed). In some implementations, the received request may not define how the innovation methodology template is to determine when and by whom role-based tasks are to be completed for idea development projects. In such implementations, the back-end computing platform 202 may create the state machine, or otherwise configure the innovation methodology template, to determine when and by whom role-based tasks are to be completed for idea development projects based on (i) the set of roles and (ii) the set of phases that are included in the received request.

In implementations where the requested innovation methodology template is a predefined innovation methodology template, then the back-end computing platform 202 may utilize an existing data structure that has been created for the predefined innovation methodology template, instead of creating a new data structure. The back-end computing platform 202 may create the innovation methodology template in other ways as well.

At block 306, the back-end computing platform 202 may store the created innovation methodology template, e.g., within the storage 208. In implementations where the back-end computing platform 202 creates a state machine to implement the innovation methodology template, the state machine may be stored (i) together with the innovation methodology template or (ii) as part of the innovation methodology template). In practice, the back-end computing platform 202 may perform the operations of block 302-306 multiple times, storing any number of innovation methodology templates within the storage 208 to make up the plurality of innovation methodology templates 210. Further, in implementations where a requested innovation method is a predefined innovation methodology template, the predefined innovation methodology template may already be stored in the storage 208, in which case the back-end computing platform 202 may not need to store the predefined innovation methodology template again. Rather, the back-end computing platform 202 may instead store an indication that the predefined innovation methodology template has been requested, such that the predefined innovation methodology template may be stored or otherwise indicated within the plurality of innovation methodology templates 210. Other possibilities may also exist.

Turning now to FIG. 4, an example flow diagram 400 shows one possible example of operations that may be carried out to create a data object for an idea development project using an innovation methodology template, in accordance with the present disclosure. As shown, the operations of the example flow diagram 400 are performed by a first client device 204 that is running client-side software for the ideation hub software application, which may be operated by a user seeking to submit a new idea, the back-end computing platform 202, and a second client device 204 that is running client-side software for the ideation hub software application, which may be operated by a user who may be responsible for reviewing idea creation submissions and determining which idea creation submissions warrant transitioning into idea development projects. However, it should be noted that the operations of the example flow diagram 400 may be performed by other devices and/or platforms. Moreover, the blocks shown in the example flow diagram 400 may be rearranged into different orders, combined into fewer blocks, separated into additional blocks, and/or removed, based on the particular embodiment. The example flow diagram 400 may also be modified to include additional blocks that represent other functionality that is described expressly or implicitly elsewhere herein.

At block 402, the first client device 204 may receive user input for an idea creation submission. To accomplish this, the first client device 204 may first present, to a operating the first client device 204, one or more interface views for creating the idea creation submission.

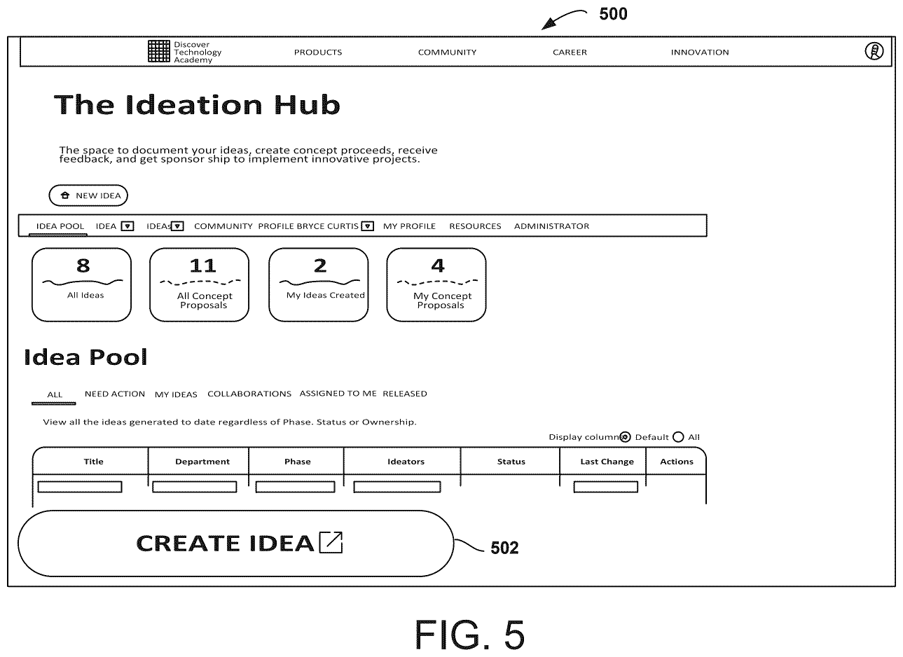

FIG. 5 illustrates an example visualization 500 of a first interface view that may be presented by the first client device 204. For instance, a user operating the first client device 204 may sign into the ideation hub software application (e.g., in the manner previously described) and then navigate through the ideation hub software application to the interface shown in the example visualization 500. As shown, the example visualization 500 includes, among other things, a selectable icon 502 for beginning the process of creating an idea creation submission. Upon detecting a user selection of the selectable icon 502, the first client device 204 may be configured to present a second interface view showing an idea creation form, which may correspond to the idea creation phase previously described. The idea creation form may include a set of tasks that are to be completed by the user seeking to create the idea creation submission, which may include (i) tasks to describe the new idea and (ii) tasks to recruit one or more entities to collaborate on the idea development project, among other possible tasks.

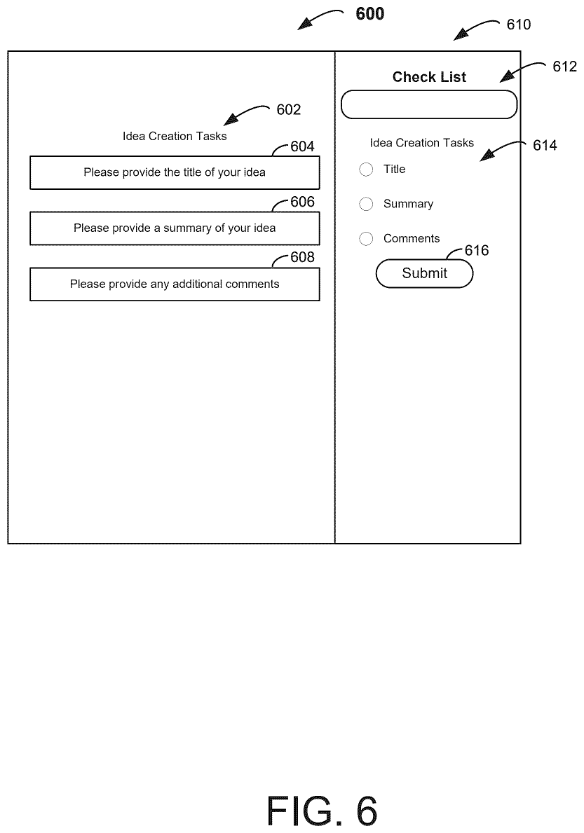

FIG. 6 shows an example visualization 600 of the second interface view described above. As shown in FIG. 6, the example visualization 600 includes a set of input fields 602 for completing one or more tasks. As shown, the set of input fields 602 may include a first input field 604 for completing a task of inputting a title for the new idea development project, a second input field 606 for completing a task of inputting a summary of the new idea development project, and a third input field 608 for completing a task of inputting any comments or additional information for the new idea development project. Although not shown, the set of input fields 602 may include various other input fields. The example visualization 600 may also include a side panel 610 that may provide an overview of the status of the idea development project. As shown, the side panel 610 includes a progress bar 612 that indicates to what extent the tasks of the idea creation form have been completed. The side panel also includes a checklist 614 that tracks includes indications of whether tasks of the one or more tasks have been completed. For instance, when a task of the idea creation form is completed, the checklist 614 may be updated to reflect the completion of that task.

In some implementations, one or more tasks of the idea creation form may not be required in order to complete the idea creation form. Instead, certain tasks of the idea creation form may be “recommended” tasks, which may help provide additional information or context for the idea. In the example shown in FIG. 6, the tasks of inputting a title of the new idea and inputting a summary for the new idea may be required to complete the idea creation form, whereas the task for inputting comments for the new idea may be an optional task. This is reflected in the checklist 614, which (i) includes indications of the tasks of inputting a title of the new idea and inputting a summary for the new idea, but (ii) does not include an indication of the task of inputting a comment for the new idea. The progress bar 612 may also take into account which tasks are required and which are not. For instance, the progress bar 612 may update when required tasks are completed, but may not update when non-required tasks are completed.

The side panel 610 may include an icon 616 for submitting the new idea described in the idea creation form. In some implementations, the icon 616 may not be selectable until the required tasks of the idea creation form have been completed, at which point the icon 616 may become selectable for submitting the new idea.

It should be understood that the idea creation form may take various other forms in addition to or instead of what is shown in the example visualization 600, including an option to recruit one or more entities to collaborate on the idea development project (e.g., either within the set of input fields 602 or within the side panel 610, among other possibilities). Further, the side panel 610 may take the form of a pop-up window instead of a side panel. Other examples may also exist.

After completing the required tasks of the idea creation form, the user may select the icon 616 to complete the idea creation submission. Upon detecting the user selection of the icon 616, the first client device 204 may generate an indication of the idea creation submission, e.g., based on the information input to the idea creation form.

Returning to FIG. 4, at block 404, the first client device 204 may transmit the indication of the idea creation submission to the back-end computing platform 202, e.g., via the communication path between the first client device 204 and the back-end computing platform 202.

At block 406, the back-end computing platform 202 may receive, and then store, the indication of the idea creation submission. For instance, the back-end computing platform 202 may receive the indication of the idea creation submission from the first client device 204, e.g., via the communication path between the first client device 204 and the back-end computing platform 202. The back-end computing platform 202 may store the indication of the idea creation submission within the storage 208. In practice, the operations of blocks 402-406 may be performed multiple times, such that the back-end computing platform 202 may store any number of indications of idea creation submissions within the storage 208. Although not shown in FIG. 2, the storage 208 may also include a plurality of indications of idea creation submissions that are stored by the back-end computing platform 202.

At block 408, the second client device 204 may receive user input indicating a request to view an idea creation submission. In line with the previous discussion, the user operating the second client device 204 may be responsible for reviewing idea creation submissions and determining which idea creation submissions warrant transitioning into idea development projects. To accomplish this, the user may navigate through the ideation hub software application to select an option to review idea creation submissions, such as (i) an option to review any recently created idea creation submissions and/or (ii) an option to review any idea creation submissions that are assigned to the user for review, among other possibilities. In practice, the selection of this option may be the user input received by the second client device 204. Then, at block 410, the second client device 204 may transmit the request to view the idea creation submission to the back-end computing platform 202, e.g., via the communication path between the second client device 204 and the back-end computing platform 202.

At block 412, the back-end computing platform 202 may receive the request for the idea creation submission e.g., via the communication path between the second client device 204 and the back-end computing platform 202. Then, at block 414, the back-end computing platform 202 may transmit an indication of the idea creation submission to the second client device 204, e.g., via the communication path between the second client device 204 and the back-end computing platform 202. In some implementations, the back-end computing platform 202 may transmit the indication of the idea creation submission to the second client device 204 without having first received a request for the idea creation submission from the second client device 204. For instance, the back-end computing platform 202 may be configured to provide the indication of the idea creation submission to the second client device 204 automatically, e.g., after receiving and storing the indication of the idea creation submission. Other possibilities may also exist.

At block 416, the second client device 204 may receive and then present the indication of the idea creation submission to the user operating the second client device 204. The user operating the second client device 204 may then review the idea creation submission to determine whether the idea creation submission warrants transitioning into an idea development project. For instance, the user operating the second client device 204 may decide to sponsor the idea reflected in the idea creation submission, and may approve the creation of an idea development project for the idea. In line with the previous discussion, the user operating the second client device 204 may also assign another entity to sponsor the idea development project. Other possibilities may also exist.

If the user operating the second client device 204 decides to reject the idea creation submission, then the functionality of FIG. 4 may halt for that idea creation submission (but may continue for another idea creation submission that is approved). Alternatively, if the user operating the second client device 204 approves the idea creation submission, then the user may provide user input to the second client device 204 indicating a request to create a data object for an idea development project based on the idea creation submission, which the second client device may receive at block 418. Then, at block 420, the second client device may transmit the request to create the data object for the idea development project to the back-end computing platform 202, e.g., via the communication path between the second client device 204 and the back-end computing platform 202.

At block 422, the back-end computing platform 202 may receive the request to create the data object for the idea development project from the second client device 204, e.g., via the communication path between the second client device 204 and the back-end computing platform 202.

At block 422, the back-end computing platform 202 may create the requested data object for the idea development project. In line with the previous discussion, in some implementations, different types of idea development projects may be created by different innovation methodology templates. Accordingly, before creating the requested data object for the idea development project, the back-end computing platform 202 may first determine an innovation methodology template to use for creating the requested data object for the idea development project. The back-end computing platform 202 may determine the innovation methodology template in various ways.

As one possibility, the back-end computing platform 202 may access the information contained in the idea creation submission for which the data object for the idea development project is being created and then, based on an analysis of the information contained in the idea creation submission, determine the innovation methodology template. The back-end computing platform 202 may access this information either from (i) the storage 208, where the indication of the idea creation submission may be stored, in line with the previous discussion, and/or from (ii) the request to create the data object for the idea development project, e.g., in implementations where the request to create the data object for the idea development project indicates the idea creation submission for which the data object for the idea development project is to be created. The back-end computing platform 202 may access the information contained in the idea creation submission in other ways as well.

Further, the analysis of the information contained in the idea creation submission may take various forms. As certain innovation methodology templates may be applicable to certain types of ideas, the back-end computing platform 202 may analyze the information contained in the idea creation submission, among other possible information, to determine whether an innovation methodology template of the plurality of innovation methodology templates 210 applies to the idea described in the idea creation submission. As one example, a first innovation methodology template within the plurality of innovation methodology templates 210 may be applicable to ideas that involve software application developments, and if the back-end computing platform 202 determines that the information contained in the idea creation submission describes an idea about a software application development, then the back-end computing platform 202 may determine to use the first innovation methodology template for creating the idea development project. As another example, a second innovation methodology template within the plurality of innovation methodology templates 210 may be applicable to ideas that involve private information (e.g., customer data for customers of a financial institution). For instance, a financial institution may enact a policy that any idea development projects that involve handling private information are to be implemented by a second innovation methodology template that is designed to keep such information confidential (e.g., by requiring that a verified privacy team member be added to the idea development project as a reviewer, among other examples). In this example, if the back-end computing platform 202 determines that the information contained in the idea creation submission describes an idea that involves handling private information, then the back-end computing platform 202 may determine to use the second innovation methodology template for creating the requested data object for the idea development project. Various other examples may also exist.

As another possibility, the back-end computing platform 202 may receive an instruction to apply a given innovation methodology template for creating the requested data object for the idea development project. For instance, the request to create the data object for the idea development project may include an instruction to apply a given innovation methodology template to use for creating the data object.

As yet another possibility, the back-end computing platform 202 may be configured to apply a default innovation method for creating the requested data object for the idea development project. Various other possibilities may also exist.

After determining the innovation methodology template, the back-end computing platform 202 may then create the data object for the idea development project based on the determined innovation methodology template. The data object may take any of various forms, such as a Json object or the like. Further, the data object for the idea development project may include data representing the phases and role-based tasks that are defined by the determined innovation methodology template, along with other data. Further yet, the back-end computing platform 202 may also assign (i) an idea owner role to the user that created the idea creation submission and (ii) a sponsor role to either the user that submitted the request to create the data object or to another entity (e.g., an entity assigned by the user that submitted the request to create the data object or an entity recruited by the user having the idea owner role). Further details regarding operations performed to assign roles to entities are described below with respect to FIG. 8.

At block 426, the back-end computing platform 202 may store the created data object, e.g., within the storage 208. In practice, the operations of blocks 418-426 may be performed multiple times, such that the back-end computing platform 202 may store any number of data objects for idea development projects created by the determined innovation methodology template within the storage 208. Further, in line with the previous discussion, multiple innovation methodology templates may be stored in the plurality of innovation methodology templates 210. Accordingly, as data objects for idea development projects are being created using various of the plurality of innovation methodology templates 210, those data objects may be stored within the storage 208 to make up the plurality of data objects 212.

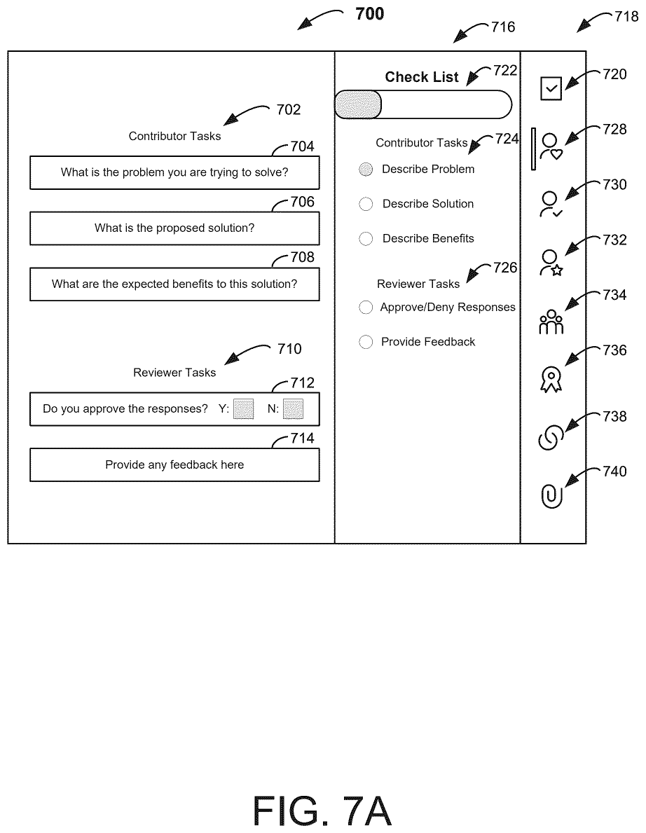

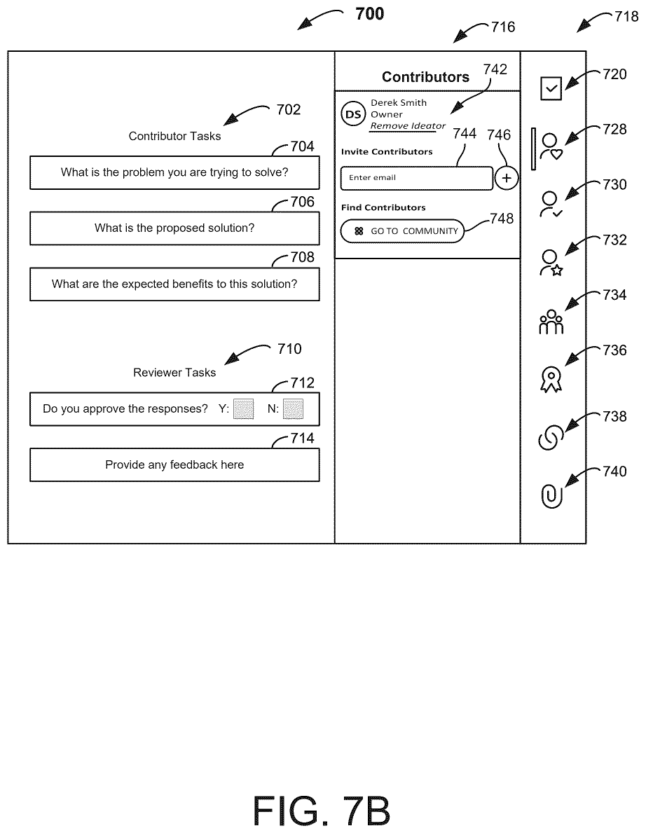

FIGS. 7A-7B illustrate example visualizations of a data object for an idea development project that may be created by the back-end computing platform 202 in line with the previous discussion. Further, the example visualizations of FIGS. 7A-7B may be presented by a client device 204 (e.g., operated by an user collaborating on the idea development project) that is running the client-side software for the ideation hub software application and/or a web-based application that implements the front-end functionality for the ideation hub software application.

Starting first with FIG. 7A, an example visualization 700 is shown, which may be similar in appearance to the example visualization 600 shown in FIG. 6. However, where the example visualization 600 illustrates an example idea creation form for creating idea creation submissions, the example visualization 700 illustrates an example data object for an idea development project that may be created based on an idea creation submission.

For simplicity, the example visualization 700 includes only a few of the possible roles, phases, and role-based tasks that may be defined for the data object for the idea development project. Specifically, as shown, the example visualization 700 includes (i) a first set of input fields 702 for role-based tasks that may be completed by entities having the contributor role, including (a) a first input field 704 for completing a task of inputting a problem statement, (b) a second input field 706 for inputting a proposed solution, and (c) a third input field 708 for inputting a description of the expected benefits of the proposed solution, and (ii) a second set of input fields 710 for role-based tasks that may be completed by entities having the reviewer role, including (a) a first input field 712 for approving and/or rejecting the responses input to the first set of input fields 702 and (b) a second input field 714 for providing feedback to the responses input to the first set of input fields 702. The first set of input fields 702 and the second set of input fields 710 may include more or fewer input fields than those shown in the example visualization 700.

Further, as shown, the example visualization 700 includes a side panel 716 and a menu 718 including selectable menu options. The side panel 716 may be updated to present different information, depending on which selectable menu option of the menu 718 is selected. As shown in the example visualization 700, a first selectable menu option 720 has been selected, which may cause the side panel 716 to present information for a checklist of the data object for the idea development project. As shown, this includes (i) a progress bar 722, (ii) a first checklist 724 for the first set of input fields 702, and (iii) a second checklist 726 for the second set of input fields. The progress bar 722 may indicate to what extent the tasks of the phase shown in the example visualization 700 have been completed, and each of the first checklist 724 and the second checklist 726 may track which tasks of the first set of input fields 702 and the second set of input fields 710 have been completed, respectively. As shown, only the task corresponding to the first data field 704 has been filled in. As shown, the progress bar 722 and the first checklist 724 reflect the completion of this task.

The side panel 716 may be updated to present other information as well, e.g., if other selectable menu options of the menu 718 are selected. As shown, the menu 718 includes, in addition to the first selectable menu option 720, (i) a second selectable menu option 728 for reviewing and/or managing the entities having the contributor role for collaborating on the idea development project, (ii) a third selectable menu option 730 for reviewing and/or managing the entities having the reviewer role for collaborating on the idea development project, (iii) a fourth selectable menu option 732 for reviewing and/or managing the entities having the sponsor role for collaborating on the idea development project, (iv) a fifth selectable menu option 734 for reviewing and/or managing the entities having the innovation squad member role for collaborating on the idea development project, (v) a sixth selectable menu option 736 for reviewing and/or managing any patents that may correspond to the idea development project, (vi) a seventh selectable menu option 738 for reviewing and/or managing any links that may be added to the idea development project, and (vii) an eighth selectable menu option 740 for reviewing and/or managing any attachments that may be added to the idea development project.

FIG. 7B shows the example visualization 700 after the selectable menu option 728 has been selected. As shown, the side panel 716 has been updated to now include an indication 742 of one or more entities having the contributor role that have been added to the idea development project. The side panel 716 also now includes (i) an input field 744 for inputting identification information (e.g., an email address) for an entity to be recruited to collaborate on the idea development project as a contributor, (ii) a selectable icon 746 for submitting a recruitment request for the entity identified in the input field 744, and (iii) a selectable icon 748 for navigating to a community hub interface for finding entities to recruit to collaborate on the idea development project. Although the side panel 716 only shows one input field 744 for inputting identification information for an entity to be recruited, in practice the side panel 716 may be updated to include multiple input fields.

The side panel 716 may be updated in a similar way when any of the selectable menu options 730-734 are selected, e.g., to show similar information for reviewing/managing entities having the reviewer role, sponsor role, and innovation squad member role, respectively. Further, although not shown, selection of the other selectable menu options 736-740 may also update the side panel 716 to include various other kinds of information.

For instance, when the selectable menu option 736 is selected, the side panel 716 may be updated to include (i) a selectable icon to navigate to an interface view for any patent applications that may be related to the idea development project and possibly (ii) a selectable icon to begin a process for preparing a new patent disclosure form related to the idea development project. In line with the previous discussion, the ideation hub service 206 may be configured to begin the process for preparing a new patent disclosure form by importing information from the idea development project to the patent disclosure form (e.g., including inventor information, as well as disclosure information). The side panel 716 may be updated in other ways as well when the selectable menu option 736 is selected.

Additionally, when the selectable menu option 738 is selected, the side panel 716 may be updated to include (i) any links that have been created for the idea development project, and possibly (ii) an input field or other type of selectable icon for adding a new link to the idea development project. The side panel 716 may be updated in other ways as well when the selectable menu option 738 is selected.

Additionally yet, when the selectable menu option 740 is selected, the side panel 716 may be updated to include (i) any attachments that have been created for the idea development project, and possibly (ii) an input field or other type of selectable icon for adding a new attachment to the idea development project. The side panel 716 may be updated in other ways as well when the selectable menu option 740 is selected.

In line with the previous discussion, entities may be added to collaborate on idea development projects. FIG. 8 includes an example flow diagram 800 that shows one possible example of operations that may be carried out to add entities to an idea development project in accordance with the present disclosure. As shown, the operations of the example flow diagram 800 are performed by the back-end computing platform 202, although it should be noted that the operations of the example flow diagram 800 may be performed by other devices and/or platforms. Moreover, the blocks shown in the example flow diagram 800 may be rearranged into different orders, combined into fewer blocks, separated into additional blocks, and/or removed, based on the particular embodiment. The example flow diagram 800 may also be modified to include additional blocks that represent other functionality that is described expressly or implicitly elsewhere herein.

At block 802, the back-end computing platform 202 may receive, from a first client device 204, a request to add an entity to an idea development project. The request may include various types of information. As one example, the request may include identification information for the entity to be added, such as an identifier of a profile used by the entity for the ideation hub software application and/or an email of the entity, etc. As another example, the request may include an indication of the role to be granted to the entity. As yet another example, the request may include an indication of credentials held by the entity that may qualify the entity to hold certain roles for the idea development project. For instance, if the entity is a manager at the enterprise utilizing the ideation hub software application, the credentials of being a manager may qualify the entity to be a reviewer for the idea development project. Various other examples may also exist.

The first client device 204 may transmit the request to add the entity to the idea development project based on user input received from a user operating the first client device 204. As one example, in line with the previous discussion, the first client device 204 may transmit the request based on user input to the input field 744 of FIG. 7B indicating the entity to be recruited to join the idea development project as a contributor. As another example, the first client device 204 may transmit the request based on user input provided via a community hub interface view, in line with the previous discussion. For instance, the community hub interface view may include functionality for searching for various entities that may be recruited from a pool of entities. In line with various examples described above, the ideation hub service 206 may be utilized by an enterprise, and the pool of entities may include employees of the enterprise, along with other parties that may in a collaborative relationship with the enterprise.

FIG. 9 illustrates an example visualization 900 of a community hub interface view that may be presented via the first client device 204, e.g., while the first client device 204 is running the client-side software for the ideation hub software application and/or a web-based application that implements the front-end functionality for the ideation hub software application. As shown, the example visualization 900 includes a dropdown list 902 for filtering entities by role. For instance, each entity may have credentials to hold certain roles (e.g., a manager may have the credentials to hold a reviewer role, etc.), and the user operating the first client device 204 may select one or more role options from the dropdown list 902 to filter the entities from the pool of entities. The example visualization 900 also includes a dropdown list 904 for filtering entities by expertise. For instance, some entities may be experienced in blockchain technologies, while other entities may be experienced in business strategy. Depending on the subject matter involved in the idea development project, the user operating the first client device 204 may desire to identify and recruit entities having certain areas of expertise, and may select one or more expertise options from the dropdown list 904 to filter the entities from the pool of entities. The community hub interface view may include other dropdown lists in addition to or instead of the dropdown lists 902-904 for filtering entities from the pool of entities. For instance, there may be dropdown lists, or other selectable icons, for filtering entities by (i) name, (ii) skills, and/or (iii) interests, among other examples.

The example visualization 900 also includes a table 906 showing the pool of entities as filtered. The user operating the first client device 204 may be able to select entities from the table 906 to recruit them to collaborate on the idea development project.

Further, in some implementations, the user operating the first client device 204 may provide user input to submit a request to join an idea development project, rather than a request to recruit an entity to collaborate on an idea development project. As one example, the user may navigate to a visualization of a data object for an idea development project, similar to the example visualization 700 of FIG. 7B, but instead of including the input field 744, the visualization of the data object for the idea development project presented to the user may include a different input field for submitting a request to join the idea development project as a collaborator. As another example, the user may navigate to the community hub interface view, which may provide functionality for searching for idea development projects that the user may request to join. For instance, similar to the example visualization 900 shown in FIG. 9, the community hub interface view presented to the user may also include one or more dropdown lists and a table. However, the table may show idea development projects that the user may request to join, and the dropdown lists may be for filtering the idea development projects. For instance, the idea development projects may correspond to the plurality of data objects for idea development projects stored in the storage 208 of the back-end computing platform 202.

In implementations where the user requests to join an idea development project, the user may be added to the idea development project in various ways. As one possibility, the user may be added automatically. As another possibility, the request may need to be approved, e.g., by the idea owner for the idea development project or another entity. Further, in implementations where the request includes an indication of a role that the user may desire to have for the idea development project, the role may be approved, applied by default, or possibly revised, e.g., by the idea owner for the idea development project or another entity. Various other examples may also exist.

Returning to FIG. 8, at block 804, the back-end computing platform 202 may determine a set of access permission settings for the entity. In line with the previous discussion, the innovation methodology template may define a respective set of permission settings for each role defined by the innovation methodology template, wherein the respective set of permission settings includes the various rules that determine when entities having the role may access role-based tasks corresponding to the role.

In line with the previous discussion, access to role-based tasks included in the idea development project may be restricted both (i) to entities having corresponding roles for the idea development project as well as (ii) to times when the phases including the role-based tasks are open. For instance, role-based tasks for a given role may be included in multiple phases of the idea development project, and entities having the given role may be able to access the role-based tasks for each phase when the phase is open. On the other hand, even if an entity has a role that corresponds to a given role-based task, if the role-based task is in a closed phase, the entity may nonetheless be restricted from completing the given role-based task.

In some implementations, the set of access permissions may be more granular. For instance, even if a phase is open, some tasks within the phase may not be completed until one or more conditions are met. To illustrate with an example, a given phase of the idea development project may include, among other things, (i) a first task to describe the solution proposed in the idea development project that is to be completed by an entity having the contributor role for the idea development project, and (ii) a second task to approve or reject the response to the first task, wherein the second task may be completed by an entity having the reviewer role for the idea development project. However, even though the given phase is open, an entity having the reviewer role for the idea development project may be restricted from completing the second task until the first task has been completed. Looking at the example visualization 700 of FIG. 7A, for instance, the tasks corresponding to the second set of tasks 710 may not be completed until the tasks corresponding to the first set of tasks 702 have been completed first. Various other examples may also exist.

To determine the set of access permission settings for the entity, the back-end computing platform 202 may (i) determine the role that is to be assigned to the entity, e.g., as indicated in the request received from the first client device 204, and (ii) identify which set of access permission settings is defined by the innovation methodology template for the determined role. The back-end computing platform 202 may determine the set of access permission settings for the entity in other ways as well.

At block 806, the back-end computing platform 202 may store an indication of the determined set of access permission settings for the entity within the storage 208. In practice, the stored indication may include (i) an identifier for the entity, such as the identity information for the entity included in the request, (ii) an identifier of the role to be assigned to the entity, and/or (iii) the set of access permission settings defined by the innovation methodology template for the role to be assigned to the entity, among other possibilities. In practice, the back-end computing platform 202 may perform the operations of block 802-806 multiple times, storing an indication of the set of access permission settings for each entity added to the idea development project. In implementations where multiple entities are assigned a same role, those entities may have the same set of access permission settings, in which case the back-end computing platform 202 may not need to store a separate set of access permission settings for each entity. Instead, the back-end computing platform 202 may store an indication of which entities are assigned to which roles, thereby associating each entity with the set of access permission applying to the entity. Further, in line with the previous discussion, multiple innovation methodology templates may be stored in the plurality of innovation methodology templates 210. Accordingly, as entities as assigned roles for idea development projects managed by one or more innovation methodology templates, the sets of access permission settings for each role—for each innovation methodology template—may be stored in the storage 208 to make up the plurality of sets of access permission settings 214 of FIG. 2. Further, in line with the previous discussion, an entity may be involved in multiple idea development projects, and may have a respective role for each idea development project. As such, multiple sets of access permission settings may be stored for a given entity, e.g., a respective set of access permission settings for each idea development project that the entity is involved in. Further yet, in at least some implementations, it may be possible for an entity to have more than one role on a given idea development project, which may also be reflected in the set of access permission settings for the entity. Other possibilities may also exist.

At block 808, the back-end computing platform 202 may receive, from a second client device, a request to access the data object for the idea development project, e.g., via the communication path between the second client device 204 and the back-end computing platform 202. For instance, a user operating the second client device 204 may sign into the ideation hub software application (e.g., in implementations where the user already has an account) and then navigate through the ideation hub software application to select an option to view the idea development project, e.g., which may be included in a community hub interface view or the like. The second client device 204 may then, based on detecting the selection of the option to view the idea development project, transmit the request to access the data object for the idea development project to the back-end computing platform 202.

The request received from the second client device 204 may include various types of information. As one example, the request may include identification information for the user requesting to access the data object for the idea development project. For instance, when the user creates an account (or is added as a user to an account) with the ideation hub software application, a unique identifier for the user may be created (e.g., at the back-end computing platform 202) and stored locally on the second client device 204 (and possibly within the storage 208 of the back-end computing platform 202 as well). The second client device 204 may use this unique identifier to identify the user in the request transmitted to the back-end computing platform 202.

As another example, the request may include information indicating the role of the user requesting to access the data object for the idea development project, in implementations where the user has already been assigned a role for collaborating on the idea development project. In implementations where the user has not yet been added to the idea development project, then the request may not include such information.

The request may include other information as well.

At block 810, the back-end computing platform 202 may determine an access permission setting for the user. The back-end computing platform 202 may determine the access permission setting for the user in various ways. As one possibility, the back-end computing platform 202 may determine whether the identification information for the user—which may be included in the request received at block 808—is included in the storage 208 as being associated with a role defined by the innovation methodology template for the idea development project, and relatedly, a corresponding set of access permission settings stored in the storage 208. If the back-end computing platform 202 determines that the identification information for the user is included in the storage 208, then the back-end computing platform 202 may further determine which access permission setting applies to the idea development project, e.g., based on which phase of the idea development project is open, among other rules that may be defined by the set of access permission settings. In implementations where the identification information for the user received at block 808 is not included in the storage 208 as being associated with a role defined by the innovation methodology template for the idea development project, then the back-end computing platform 202 may determine a default access permission setting for the user, which may enable the user to (i) request to join the idea development project and possibly (ii) view one or more tasks of the idea development project.

At block 812, the back-end computing platform 202 may cause the second client device 204 to present the data object for the idea development project according to the determined access permission setting for the user. For instance, the back-end computing platform 202 may transmit an indication of the access permission setting for the user, and the second client device 204 may, cause a visualization of the data object for the idea development project to be presented that includes a certain amount of information based on the indication of the access permission setting for the user. For instance, depending on (i) the role held by the user and (ii) the phase that is open, among other possible rules defined by the access permission setting, the visualization of the data object for the idea development project may include various role-based tasks that may be completed by the user, along with possibly role-based tasks that may not be completed by the user, but that may be viewable (but not editable) by the user. This may enable the user to complete certain role-based tasks (but not others) to progress the idea development project.

In practice, the operations of FIG. 8 may be completed repeatedly as new entities are added to the idea development project and as the idea development project progresses through the various phases defined by the innovation methodology template (e.g., as tasks are completed). As entities engage in activity to complete role-based tasks assigned to them (e.g., by providing responses to questions, adding links and attachments to the idea development project, etc.), the client devices 204 operated by the entities may transmit indications of this activity to the back-end computing platform 202, which may update the data object for the idea development project to reflect the activity, e.g., within the storage 208. Then, the back-end computing platform 202 may transmit visualizations of the updated data object to the client devices 204, such that each entity is able to see the progression of the idea development project as tasks are completed by collaborating entities. In line with the previous discussion, the back-end computing platform 202 may utilize a state machine to implement the innovation methodology template for the idea development project. The back-end computing platform 202 may implement the innovation methodology template for the idea development project in various other ways as well.

In order to complete the idea development project, the innovation methodology template may also define a final work product that is to be delivered to an entity responsible for producing, launching, or otherwise taking responsibility for the completed idea development project. This final product may take various forms and may be referred to herein as a “project dossier.” The project dossier may represent the collection of all work created during each phase of the idea development project, including records of all of the tasks completed for the idea development project, all of the links added to the idea development project, all of the attachments added to the idea development project, etc. This project dossier may enable the entity responsible for producing, launching, or otherwise taking responsibility for the idea development project to have a clear understanding of the parameters involved in the idea development project.

Further, in line with the previous discussion, an entity may be involved in multiple idea development projects, and may have a respective role for each idea development project. In this way, the entity may complete different kinds of role-based tasks for different idea development projects, depending on the role assigned to the entity for each idea development project.

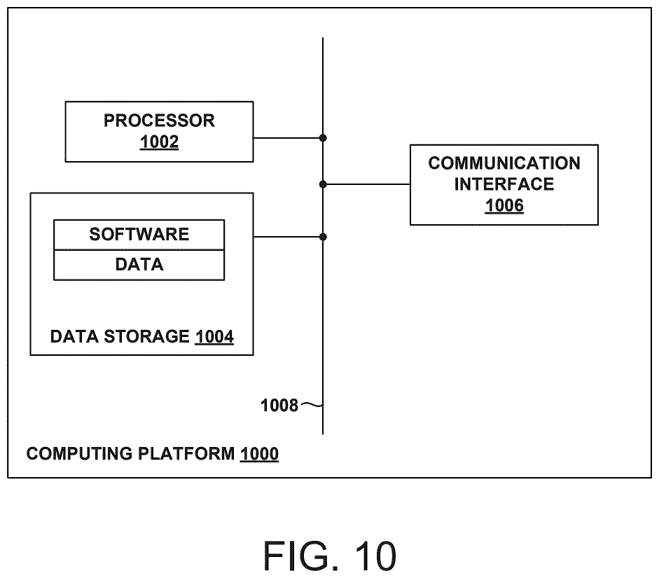

Turning now to FIG. 10, a simplified block diagram is provided to illustrate some structural components that may be included in an example computing platform 1000 that may be configured to perform the server-side functions disclosed herein. At a high level, the example computing platform 1000 may generally comprise any one or more computer systems (e.g., one or more servers) that collectively include one or more processors 1002, data storage 1004, and one or more communication interfaces 1006, each of which may be communicatively linked by a communication link 1008 that may take the form of a system bus, a communication network such as a public, private, or hybrid cloud, or some other connection mechanism. Each of these components may take various forms.

For instance, the one or more processors 1002 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 1002 could comprise processing components that are distributed across a plurality of physical computing devices connected via a network, such as a computing cluster of a public, private, or hybrid cloud.

In turn, the data storage 1004 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 1004 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 10, the data storage 1004 may be capable of storing both (i) program instructions that are executable by the one or more processors 1002 such that the example computing platform 1000 is configured to perform any of the various functions disclosed herein (including but not limited to any of the server-side functions discussed above), and (ii) data that may be received, derived, or otherwise stored by the example computing platform 1000.

The one or more communication interfaces 1006 may comprise one or more interfaces that facilitate communication between the example computing platform 1000 and other systems or devices, where each such interface may be wired and/or wireless and may communicate according to any of various communication protocols. As examples, the one or more communication interfaces 1006 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 1000 may additionally have an Input/Output (I/O) interface that includes or provides connectivity to I/O components that facilitate user interaction with the example computing platform 1000, such as a keyboard, a mouse, a trackpad, a display screen, a touch-sensitive interface, a stylus, a virtual-reality headset, and/or one or more speaker components, among other possibilities.

It should be understood that the example computing platform 1000 is one example of a computing platform that may be used with the examples described herein. Numerous other arrangements are possible and contemplated herein. For instance, in other examples, the example computing platform 1000 may include additional components not pictured and/or more or less of the pictured components.

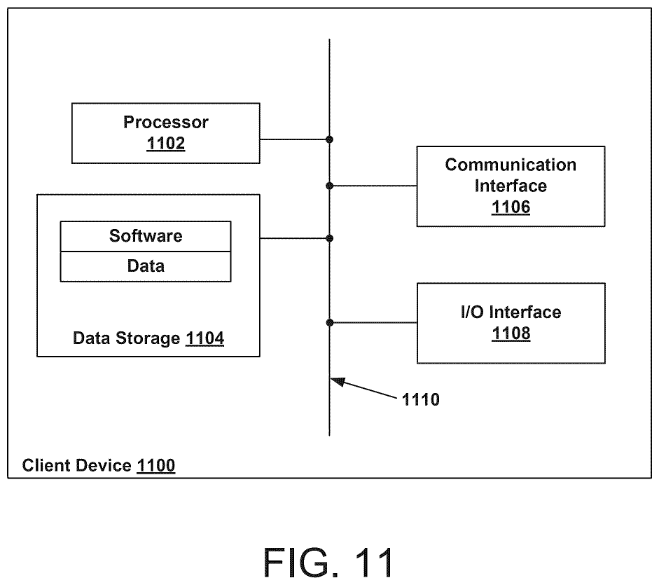

Turning next to FIG. 11, a simplified block diagram is provided to illustrate some structural components that may be included in an example client device 1100 that may be configured to perform some the client-side functions disclosed herein. At a high level, the example client device 1100 may include one or more processors 1102, data storage 1104, one or more communication interfaces 1106, and an I/O interface 1108, each of which may be communicatively linked by a communication link 1110 that may take the form a system bus and/or some other connection mechanism. Each of these components may take various forms.

For instance, the one or more processors 1102 of the example client device 1100 may comprise one or more processor components, such as one or more CPUs, GPUs, ASICs, DSPs, and/or programmable logic devices such as FPGAs, among other possible types of processing components.

In turn, the data storage 1104 of the example client device 1100 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 11, the data storage 1104 may be capable of storing both (i) program instructions that are executable by the one or more processors 1102 of the example client device 1100 such that the example client device 1100 is configured to perform any of the various functions disclosed herein (including but not limited to any of the client-side functions discussed above), and (ii) data that may be received, derived, or otherwise stored by the example client device 1100.

The one or more communication interfaces 1106 may comprise one or more interfaces that facilitate communication between the example client device 1100 and other systems or devices, where each such interface may be wired and/or wireless and may communicate according to any of various communication protocols. As examples, the one or more communication interfaces 1106 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 1108 may generally take the form of (i) one or more input interfaces that are configured to receive and/or capture information at the example client device 1100 and (ii) one or more output interfaces that are configured to output information from the example client device 1100 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 1108 may include or provide connectivity to output components such as a display screen and/or an audio speaker, among other possibilities.

It should be understood that the example client device 1100 is one example of a client device that may be used with the examples described herein. Numerous other arrangements are possible and contemplated herein. For instance, in other examples, the example client device 1100 may include additional components not pictured and/or more or fewer of the pictured components.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

We claim:

1. A computing platform comprising:
at least one processor;
at least one non-transitory computer-readable medium; and
program instructions stored on the at least one non-transitory computer-readable medium that, when executed by the at least one processor, cause the computing platform to:
create an innovation methodology template for an idea development project, the innovation methodology template defining (i) a set of roles for respective users collaborating on the idea development project, (ii) a set of phases for the idea development project comprising at least a first phase and a second phase, wherein the first phase and second phase each comprise a respective set of role-based tasks that may be completed by users having a first role of the set of roles, and (iii) a respective set of access permission settings for each role of the set of roles, wherein each set of access permission settings defines which role-based tasks users having the role can complete for the idea development project;
create a data object for the idea development project based on the created innovation methodology template;
while the first phase is open, receive, from a client device associated with a user having the first role for the idea development project, a first request to access the data object for the idea development project;
based on the set of access permission settings for the first role, cause the client device to present a first visualization of the data object for the idea development project, wherein the first presented visualization (i) includes selectable elements for the set of role-based tasks for the first phase of the idea development project corresponding to the first role, (ii) enables the user to complete the set of role-based tasks for the first phase of the idea development project corresponding to the first role, and (iii) restricts the user from completing other role-based tasks;
after the first phase is closed and while the second phase is open, receive, from the client device associated with the user having the first role for the idea development project, a second request to access the data object for the idea development project; and
based on the set of access permission settings for the first role, cause the client device to present a second visualization of the data object for the idea development project, wherein the second presented visualization (i) includes selectable elements for the set of role-based tasks for the second phase of the idea development project corresponding to the first role, (ii) enables the user to complete the set of role-based tasks for the second phase of the idea development project corresponding to the first role, and (iii) restricts the user from completing other role-based tasks.

2. The computing platform of claim 1, wherein the second phase further comprises a set of role-based tasks that may be completed by users having a second role of the set of roles, and wherein the second presented visualization also includes nonselectable elements for the set of role-based tasks for second phase of the idea development project corresponding to the second role.

3. The computing platform of claim 1, wherein the second presented visualization also includes nonselectable elements for the set of role-based tasks for the first phase of the idea development project corresponding to the first role.

4. The computing platform of claim 1, further comprising program instructions stored on the at least one non-transitory computer-readable medium that, when executed by the at least one processor, cause the computing platform to:
receive an indication of a request to create the innovation methodology template; and
wherein the program instructions that, when executed by the at least one processor, cause the computing platform to create the innovation methodology template comprise program instructions that, when executed by the at least one processor, cause the computing platform to create the innovation methodology template based on the received indication of the request to create the innovation methodology template.

5. The computing platform of claim 1, wherein:
the client device associated with the user is a first client device associated with a first user;
the first phase further comprises a set of role-based tasks that may be completed by users having a second role of the set of roles; and
the computing platform further comprises program instructions stored on the at least one non-transitory computer-readable medium that, when executed by the at least one processor, cause the computing platform to:
while the first phase is open, receive, from a second client device associated with a second user having the second role for the idea development project, a third request to access the data object for the idea development project; and
based on the set of access permission settings for the second role, cause the second client device to present a third visualization of the data object for the idea development project, wherein the third presented visualization (i) includes the set of role-based tasks for the first phase of the idea development project corresponding to the second role, (ii) enables the second user to complete the set of role-based tasks for the first phase of the idea development project corresponding to the second role, and (iii) restricts the second user from completing other role-based tasks.

6. The computing platform of claim 5, wherein the third presented visualization also includes nonselectable elements for the set of role-based tasks for first phase of the idea development project corresponding to the first role.

7. The computing platform of claim 5, wherein the second phase further comprises a set of role-based tasks that may be completed by users having the second role, and wherein the computing platform further comprises program instructions stored on the at least one non-transitory computer-readable medium that, when executed by the at least one processor, cause the computing platform to:
while the second phase is open, receive, from the second client device associated with the second user having the second role for the idea development project, a fourth request to access the data object for the idea development project; and
based on the set of access permission settings for the second role, cause the second client device to present a fourth visualization of the data object for the idea development project, wherein the fourth presented visualization (i) includes the role-based tasks for the second phase of the idea development project corresponding to the second role, (ii) enables the second user to complete the role-based tasks for the second phase of the idea development project corresponding to the second role, and (iii) restricts the second user from completing other role-based tasks.

8. The computing platform of claim 1, wherein the data object for the idea development project is a first data object for a first idea development project, the computing platform further comprising program instructions stored on the at least one non-transitory computer-readable medium that, when executed by the at least one processor, cause the computing platform to:
create a second data object for a second idea development project based on the created innovation methodology template.

9. A non-transitory computer-readable medium, wherein the non-transitory computer-readable medium is provisioned with program instructions that, when executed by at least one processor, cause a computing platform to:
create an innovation methodology template for an idea development project, the innovation methodology template defining (i) a set of roles for respective users collaborating on the idea development project, (ii) a set of phases for the idea development project comprising at least a first phase and a second phase, wherein the first phase and second phase each comprise a respective set of role-based tasks that may be completed by users having a first role of the set of roles, and (iii) a respective set of access permission settings for each role of the set of roles, wherein each set of access permission settings defines which role-based tasks users having the role can complete for the idea development project;
create a data object for the idea development project based on the created innovation methodology template;
while the first phase is open, receive, from a client device associated with a user having the first role for the idea development project, a first request to access the data object for the idea development project;
based on the set of access permission settings for the first role, cause the client device to present a first visualization of the data object for the idea development project, wherein the first presented visualization (i) includes selectable elements for the set of role-based tasks for the first phase of the idea development project corresponding to the first role, (ii) enables the user to complete the set of role-based tasks for the first phase of the idea development project corresponding to the first role, and (iii) restricts the user from completing other role-based tasks;
after the first phase is closed and while the second phase is open, receive, from the client device associated with the user having the first role for the idea development project, a second request to access the data object for the idea development project; and
based on the set of access permission settings for the first role, cause the client device to present a second visualization of the data object for the idea development project, wherein the second presented visualization (i) includes selectable elements for the set of role-based tasks for the second phase of the idea development project corresponding to the first role, (ii) enables the user to complete the set of role-based tasks for the second phase of the idea development project corresponding to the first role, and (iii) restricts the user from completing other role-based tasks.

10. The non-transitory computer-readable medium of claim 9, wherein the second phase further comprises a set of role-based tasks that may be completed by users having a second role of the set of roles, and wherein the second presented visualization also includes nonselectable elements for the set of role-based tasks for second phase of the idea development project corresponding to the second role.

11. The non-transitory computer-readable medium of claim 9, wherein the second presented visualization also includes nonselectable elements for the set of role-based tasks for the first phase of the idea development project corresponding to the first role.

12. The non-transitory computer-readable medium of claim 9, wherein the non-transitory computer-readable medium is also provisioned with program instructions that, when executed by at least one processor, cause the computing platform to:
receive an indication of a request to create the innovation methodology template; and
wherein the program instructions that, when executed by at least one processor, cause the computing platform to create the innovation methodology template comprise program instructions that, when executed by at least one processor, cause the computing platform to create the innovation methodology template based on the received indication of the request to create the innovation methodology template.

13. The non-transitory computer-readable medium of claim 9, wherein:
the client device associated with the user is a first client device associated with a first user;
the first phase further comprises a set of role-based tasks that may be completed by users having a second role of the set of roles; and
the non-transitory computer-readable medium is also provisioned with program instructions that, when executed by at least one processor, cause the computing platform to:
while the first phase is open, receive, from a second client device associated with a second user having the second role for the idea development project, a third request to access the data object for the idea development project; and
based on the set of access permission settings for the second role, cause the second client device to present a third visualization of the data object for the idea development project, wherein the third presented visualization (i) includes the set of role-based tasks for the first phase of the idea development project corresponding to the second role, (ii) enables the second user to complete the set of role-based tasks for the first phase of the idea development project corresponding to the second role, and (iii) restricts the second user from completing other role-based tasks.

14. The non-transitory computer-readable medium of claim 13, wherein the third presented visualization also includes nonselectable elements for the set of role-based tasks for first phase of the idea development project corresponding to the first role.

15. The non-transitory computer-readable medium of claim 13, wherein the second phase further comprises a set of role-based tasks that may be completed by users having the second role, and wherein the non-transitory computer-readable medium is also provisioned with program instructions that, when executed by at least one processor, cause the computing platform to:
while the second phase is open, receive, from the second client device associated with the second user having the second role for the idea development project, a fourth request to access the data object for the idea development project; and
based on the set of access permission settings for the second role, cause the second client device to present a fourth visualization of the data object for the idea development project, wherein the fourth presented visualization (i) includes the role-based tasks for the second phase of the idea development project corresponding to the second role, (ii) enables the second user to complete the role-based tasks for the second phase of the idea development project corresponding to the second role, and (iii) restricts the second user from completing other role-based tasks.

16. The non-transitory computer-readable medium of claim 9, wherein the data object for the idea development project is a first data object for a first idea development project, and wherein the non-transitory computer-readable medium is also provisioned with program instructions that, when executed by at least one processor, cause the computing platform to:
create a second data object for a second idea development project based on the created innovation methodology template.

17. A method implemented by a computing platform, the method comprising:
creating an innovation methodology template for an idea development project, the innovation methodology template defining (i) a set of roles for respective users collaborating on the idea development project, (ii) a set of phases for the idea development project comprising at least a first phase and a second phase, wherein the first phase and second phase each comprise a respective set of role-based tasks that may be completed by users having a first role of the set of roles, and (iii) a respective set of access permission settings for each role of the set of roles, wherein each set of access permission settings defines which role-based tasks users having the role can complete for the idea development project;
creating a data object for the idea development project based on the created innovation methodology template;
while the first phase is open, receiving, from a client device associated with a user having the first role for the idea development project, a first request to access the data object for the idea development project;
based on the set of access permission settings for the first role, causing the client device to present a first visualization of the data object for the idea development project, wherein the first presented visualization (i) includes selectable elements for the set of role-based tasks for the first phase of the idea development project corresponding to the first role, (ii) enables the user to complete the set of role-based tasks for the first phase of the idea development project corresponding to the first role, and (iii) restricts the user from completing other role-based tasks;
after the first phase is closed and while the second phase is open, receiving, from the client device associated with the user having the first role for the idea development project, a second request to access the data object for the idea development project; and
based on the set of access permission settings for the first role, causing the client device to present a second visualization of the data object for the idea development project, wherein the second presented visualization (i) includes selectable elements for the set of role-based tasks for the second phase of the idea development project corresponding to the first role, (ii) enables the user to complete the set of role-based tasks for the second phase of the idea development project corresponding to the first role, and (iii) restricts the user from completing other role-based tasks.

18. The method of claim 17, wherein the second phase further comprises a set of role-based tasks that may be completed by users having a second role of the set of roles, and wherein the second presented visualization also includes nonselectable elements for the set of role-based tasks for second phase of the idea development project corresponding to the second role.

19. The method of claim 17, wherein the second presented visualization also includes nonselectable elements for the set of role-based tasks for the first phase of the idea development project corresponding to the first role.

20. The method of claim 17, further comprising:
receiving an indication of a request to create the innovation methodology template; and
wherein creating the innovation methodology template comprises creating the innovation methodology template based on the received indication of the request to create the innovation methodology template.
